(19) United States
(12) Patent Application Publication
(10) Pub. No.: US 2026/0153004 A1
(43) Pub. Date: Jun. 4, 2026

(54) THREADED CONNECTION EVALUATION REMOTE FROM A JOB LOCATION

(71) Applicant: WEATHERFORD TECHNOLOGY HOLDINGS, LLC, HOUSTON, TX (US)

(72) Inventors: Rainer RUEHMANN, Hannover (DE); Benjamin SACHTLEBEN, Hannover (DE)

(21) Appl. No.: 18/982,426

(22) Filed: Dec. 16, 2024

Related U.S. Application Data
(60) Provisional application No. 63/727,828, filed on Dec. 4, 2024.

(51) Int. Cl. E21B 19/16; E21B 17/042; G06Q 50/02

(52) U.S. Cl. CPC E21B 19/165; E21B 17/042; G06Q 50/02

(57) ABSTRACT

A method of threaded connection evaluation can include receiving parameters of a threaded connection process at a job location, transmitting the parameters from the job location to a central server remote from the job location, and the central server producing an evaluation of the threaded connection. An apparatus for threaded connection evaluation can include one or more sensors at a job location, the sensors configured to output threaded connection parameter measurements, a central server remote from the job location, the central server configured to produce a threaded connection evaluation, and a conversion module configured to convert the parameter measurements to a format usable by the central server to produce the threaded connection evaluation.

### CROSS-REFERENCE TO RELATED APPLICATION

This application claims the benefit of the filing date of U.S. provisional application No. ______ filed on ______. The entire disclosure of the prior application is incorporated herein by this reference for all purposes.

### BACKGROUND

This disclosure relates generally to equipment utilized and operations performed in conjunction with a subterranean well and, in one example described below, more particularly provides for threaded connection evaluation remote from a job location at which threaded connections are made-up.

Various types of tubular components can be threaded together to form tubular strings for use in a well. Tubulars used in wells can include protective wellbore linings (such as, casing, liner, etc.), production or injection conduits (such as, production tubing, injection tubing, screens, etc.), drill pipe and drill collars, and associated components (such as tubular couplings).

Threaded connections between tubulars are made-up during tubular running operations, and the threaded connections are broken-out when a tubular string is retrieved from a well. The make-up and break-out processes should be performed quickly, efficiently and safely.

It will, therefore, be readily appreciated that improvements are continually needed in the art of evaluating threaded connection quality. The present disclosure provides such improvements to the art.

### BRIEF DESCRIPTION OF THE DRAWINGS

FIG. 1 is a representative partially cross-sectional view of an example of a well system and associated method which can embody principles of this disclosure.

FIG. 2 is a representative side view of an example tong assembly and apparatus for evaluating threaded connection quality.

FIG. 3 is a representative schematic view of an example of the apparatus.

FIG. 4 is a representative schematic view of an example of a system for remote threaded connection evaluation.

FIG. 5 is a representative flowchart for an example of a method of evaluating threaded connections.

### DETAILED DESCRIPTION

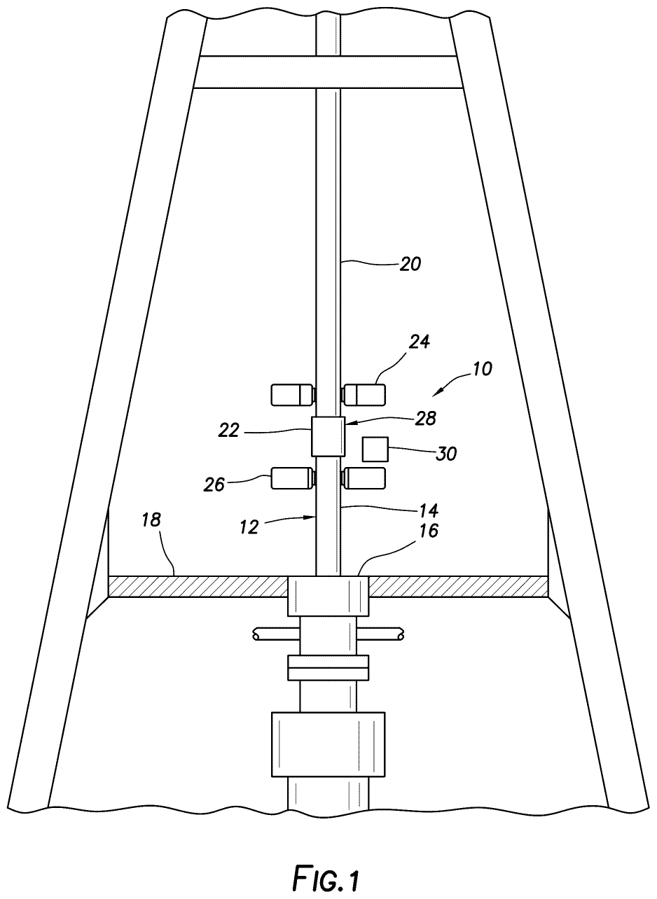

Representatively illustrated in FIG. 1 is a system 10 for use with a subterranean well, and an associated method, which can embody principles of this disclosure. However, it should be clearly understood that the well system 10 and method are merely one example of an application of the principles of this disclosure in practice, and a wide variety of other examples are possible. Therefore, the scope of this disclosure is not limited at all to the details of the well system 10 and method described herein and/or depicted in the drawings.

In the FIG. 1 example, a tubular string 12 is being assembled and deployed into a well. The tubular string 12 in this example is a production or injection tubing string, but in other examples the tubular string could be a casing, liner, drill pipe, completion, stimulation, testing or other type of tubular string. The scope of this disclosure is not limited to use of any particular type of tubular string, or to any particular tubular components connected in a tubular string.

As depicted in FIG. 1, a tubular 14 is suspended near its upper end by means of a rotary table 16, which may comprise a pipe handling spider and/or safety slips to grip the tubular 14 and support a weight of the tubular string 12. In this manner, the upper end of the tubular 14 extends upwardly through a rig floor 18 in preparation for connecting another tubular 20 to the tubular string 12.

In this example, a tubular coupling 22 is made-up to the upper end of the tubular 14 prior to the tubular 14 being connected in the tubular string 12. The coupling 22 is internally threaded in each of its opposite ends.

In conventional well operations, it is common for a threaded together tubular and coupling to be referred to as a “joint” and for threaded together joints to be referred to as a “stand” of tubing, casing, liner, pipe, etc. However, in some examples, a separate coupling may not be used; instead one end (typically an upper “box” end of a joint) is internally threaded and the other end (typically a lower “pin” end of the joint) is externally threaded, so that successive joints can be threaded directly to each other.

Thus, the scope of this disclosure can encompass the use of a separate coupling with a tubular, or the use of a tubular without a separate coupling (in which case the coupling can be considered to be integrally formed with, and a part of, the tubular). In the FIG. 1 example, the coupling 22 can also be considered to be a tubular, since it is a tubular component connected in the tubular string 12.

To make-up a threaded connection 28 between the tubular 20 and the coupling 22, a set of tongs or rotary and backup clamps 24, 26 are used. The rotary clamp 24 in the FIG. 1 example is used to grip, rotate and apply torque to the upper tubular 20 as it is threaded into the coupling 22.

The backup clamp 26 in the FIG. 1 example is used to grip and secure the lower tubular 14 against rotation, and to react the torque applied by the rotary clamp 24. The rotary clamp 24 and the backup clamp 26 may be separate devices, or they may be components of a rig apparatus known to those skilled in the art as an “iron roughneck” or a tong assembly.

In one example, the rotary clamp 24 and backup clamp 26 may be components of a tong system, such as the VERO™ tong system marketed by Weatherford International, Inc. of Houston, Texas USA. In this example, the rotary clamp 24 may be a mechanism of the tong system that rotates and applies torque to the upper tubular 20, and the backup clamp 26 may be a backup mechanism of the tong system that reacts the applied torque and prevents rotation of the lower tubular 14.

Note that it is not necessary for the tubulars 14, 20 (and coupling 22, if used) to be vertical in the tubular make-up operation. The tubulars 14, 20 could instead be horizontal or otherwise oriented. Additional systems in which the principles of this disclosure may be incorporated include the CAM™, COMCAM™ and TORKWRENCH™ bucking systems marketed by Weatherford International, Inc.

After the upper tubular 20 is properly made-up to the lower tubular 14 or coupling 22, the tubular string 12 can be lowered further into the well, and the make-up operation can be repeated to connect another stand to the upper end of the tubular string. In this manner, the tubular string 12 is progressively deployed into the well by connecting successive stands to the upper end of the tubular string. In some examples, an individual tubular component may be added to the tubular string 12, instead of a stand.

In the FIG. 1 method, it is desired to be able to evaluate a quality of the threaded connection 28 when it is made-up. In this manner, if the threaded connection 28 is acceptable, the tubular string 12 running operation can proceed efficiently. A next threaded connection 28 can then be made-up and evaluated. Preferably the evaluations of the threaded connections 28 are performed automatically, in real time, and without the need for personnel to be present on the rig floor 18.

An apparatus 30 is included in the FIG. 1 system 10 for evaluating the threaded connections 28. As described more fully below, the apparatus 30 can include a variety of different sensors to obtain measurements used to evaluate the threaded connection quality. Although the apparatus 30 is depicted in FIG. 1 as being present at a rig or other job location, various elements of the apparatus may be located remote from the rig or job location, as described more fully below.

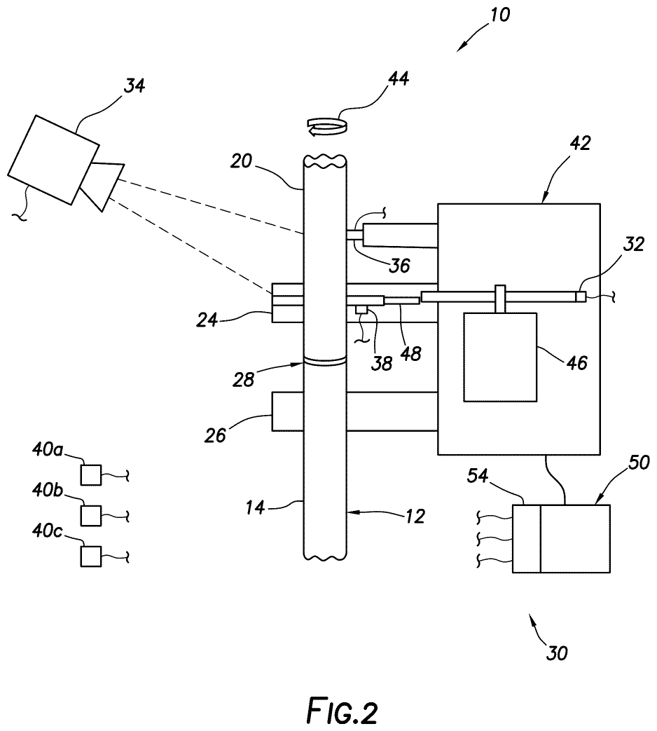

Referring additionally now to FIG. 2, an example of the apparatus 30 as used with the FIG. 1 system 10 and method is representatively illustrated. However, the apparatus 30 may be used with other systems and methods in keeping with the principles of this disclosure.

In the FIG. 2 example, a variety of different sensors 32, 34, 36, 38, 40a-c measure conditions, parameters, etc., associated with a tubular running operation. As depicted in FIG. 2, the sensor 32 is a rotation sensor, the sensor 34 is an optical sensor, the sensor 36 is a rotation sensor, the sensor 38 is a torque sensor, and the sensors 40a-c comprise environmental (such as, temperature, humidity and salt content) sensors. Other sensors, numbers of sensors, and combinations of sensors can be used in other examples for measurement of other conditions, parameters, etc.

The rotation sensor 32 outputs measurements of rotation of a motor 46 of a tong assembly 42. The rotation (and torque) output by the motor 46 is transmitted via a gear train 48 to the rotary clamp 24. Thus, the rotation output by the motor 46 and measured using the sensor 32 is directly related to the rotation of the rotary clamp 24 and the upper tubular 20 in a threaded connection make-up process.

The optical sensor 34 may comprise, for example, a camera or a laser measurement device (such as, employing light detection and ranging (LiDAR)) or a terahertz scanner. Image data output by the sensor 34 can be used to identify the locations of the tubulars 14, 20, certain features of the tubulars (such as, an upper end of the lower tubular), and rotation of one or both of the tubulars.

The rotation sensor 36 outputs direct measurements of the rotation 44 of the upper tubular 20. In this example, the sensor 36 contacts an outer surface of the upper tubular 20 with a roller, and since rotation of the roller is directly related to the rotation 44 of the tubular 20, measurements of the roller rotation output by the sensor 36 are equivalent to measurements of the tubular rotation 44.

The torque sensor 38 is configured and arranged to measure the torque applied by the rotary clamp 24 to the upper tubular 20. In this example, the torque is measured on an output side of the gear train 48, but in other examples the torque may be measured on an input side of the gear train, or at other locations.

In the FIG. 2 example, the environmental sensors 40a-c measure various environmental parameters that can affect the threaded connection make-up process. For example, the sensor 40a may comprise a temperature sensor or thermometer, thermocouple, etc. The sensor 40b may comprise a humidity sensor or hygrometer. The sensor 40c may comprise a salinometer or salinity sensor capable of measuring salt content. Other environmental sensors, numbers and combinations of sensors may be used in other examples.

A control system 50 is used to control operations in the tubular connection make-up process (e.g., completely automatically, or with human participation). For example, the control system 50 may be in wired or wireless communication with the tong assembly 42 to thereby control operation of the tong assembly during the make-up process. The control system 50 may also control operation of the tong assembly 42 during any tubular break-out operations, for example, when retrieving the tubular string 12 from the well.

The control system 50 in this example includes a conversion module 54 that receives the parameter measurement outputs from each of the sensors 32, 34, 36, 38, 40a-c during the make-up process. In one example, the sensor measurements are received in real time, while the make-up is being performed, or at least while rotation and torque are being applied to the upper tubular 20. In this manner, an evaluation of the quality of the threaded connection 28 can be quickly provided (e.g., as soon as the make-up is finished), thereby enhancing the speed and efficiency of the tubular running operation.

The evaluation of the threaded connection quality is performed at a location remote from the job location using a central server, as described more fully below. The conversion module 54 converts the parameter measurement outputs of the sensors 32, 34, 36, 38, 40a-c to a format usable by the central server to perform the threaded connection evaluation.

One potential benefit of the FIG. 2 apparatus 30 example is that the conversion module 54 can be configured to convert the parameter measurements to the format usable by the central server, regardless of whether or not the sensors 32, 34, 36, 38, 40a-c or the tong assembly 42 are provided by the same source as the central server. For example, the sensors 32, 34, 36, 38, 40a-c and the tong assembly 42 could be provided by a third party, and the conversion module 54 can still be used to convert the parameter measurements to the format usable by the central server to produce the threaded connection evaluation.

The conversion module 54 is depicted in FIG. 2 as being located at the job location, and as being included with the control system 50. However, in other examples the conversion module 54 could be included with the central server located remote from the job location. In those examples, the measured threaded connection parameters output by the sensors 32, 34, 36, 38, 40a-c would be transmitted (by wired or wireless transmission, preferably in digitized form) to the central server for storage, conversion by the conversion module 54 and use by the central server to produce the threaded connection evaluation.

In some examples described herein, a combination of cloud-based data management, processing and evaluation are used. In these examples, the cloud-based services can be integrated with third-party tubular running systems, including existing and future tubular running systems.

Measurements (such as, those output by the sensors 32, 34, 36, 38, 40a-c) and job information are pre-processed (e.g., digitized, if not already in digital format) on-site and transmitted to the cloud-based service provider. It is not necessary for the cloud-based service provider to be the same as the provider of the threaded connection parameter measurements or the job information.

With the cloud-based service, the data is used to produce visualization to users and operators (such as, a driller, an inspector, a decision maker tasked with accepting or rejecting a threaded connection, etc.). The data is managed, stored and recorded in appropriate format. Importantly, the data (e.g., sensor measurements and job information) is evaluated to determine whether the threaded connection is acceptable (e.g., whether certain requirements, such as applied torque and rotation, are satisfied). The could-based service may include artificial intelligence configured to perform the threaded connection evaluation.

When the evaluation is produced, it is transmitted back to the job location, along with any visualization, display, statistical analysis, etc., that might be useful to a driller, operator or other personnel at the job location. A decision maker tasked with accepting or rejecting the threaded connection may receive the evaluation at the job location, or at a site remote from the job location (such as, at an office of the cloud-based service provider, or at an office of a customer of the cloud-based service provider). The threaded connection is accepted or rejected, based at least in part on the evaluation.

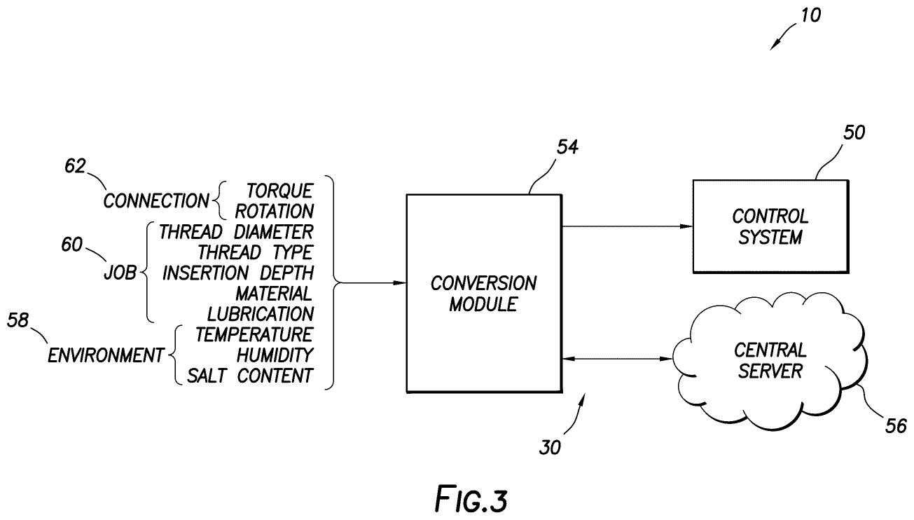

Referring additionally now to FIG. 3, an example of the apparatus 30 is representatively illustrated in schematic form. The FIG. 3 apparatus 30 may be used with the FIG. 1 or 2 system 10 and method, or it may be used with other systems and methods. For convenience, the FIG. 3 apparatus 30 is described below as it may be used with the FIG. 1 or 2 system 10 and method.

As depicted in FIG. 3, the conversion module 54 is shown as being separate from each of the control system 50 and a central server 56. However, it should be clearly understood that the conversion module 54 may be incorporated into or integrated with the control system 50 or the central server 56 in other examples.

The conversion module 54 receives the environmental measurements 58 (such as, those output by the sensors 40a-c), job information 60 (such as, specification for the tubulars being made-up, thread type, diameter, material, insertion depth, lubrication, etc., typically input by an operator) and measurements 62 obtained in the threaded connection process (such as, torque applied to the tubular 20, rotation of the tubular 20, etc., output by the sensors 32, 34, 36, 38). The conversion module 54 converts the information, measurements or other data 58, 60, 62 into a format usable by the central server 56 to perform the threaded connection evaluation. The conversion may include digitization (if data is not already in digital format), filtering, smoothing, error correction, statistical analysis, or any other appropriate data manipulation.

In some examples, the data may be provided by a third party that is different from the cloud-based service provider. In those examples, the conversion module 54 is uniquely configured to convert the third party's data format to the format usable by the central server 56 to perform the threaded connection evaluation.

The central server 56 is represented in FIG. 3 as a cloud to indicate that the central server is remote from the job location. For example, the central server 56 may be Internet-based and may be in communication with the job location via wired or wireless communication.

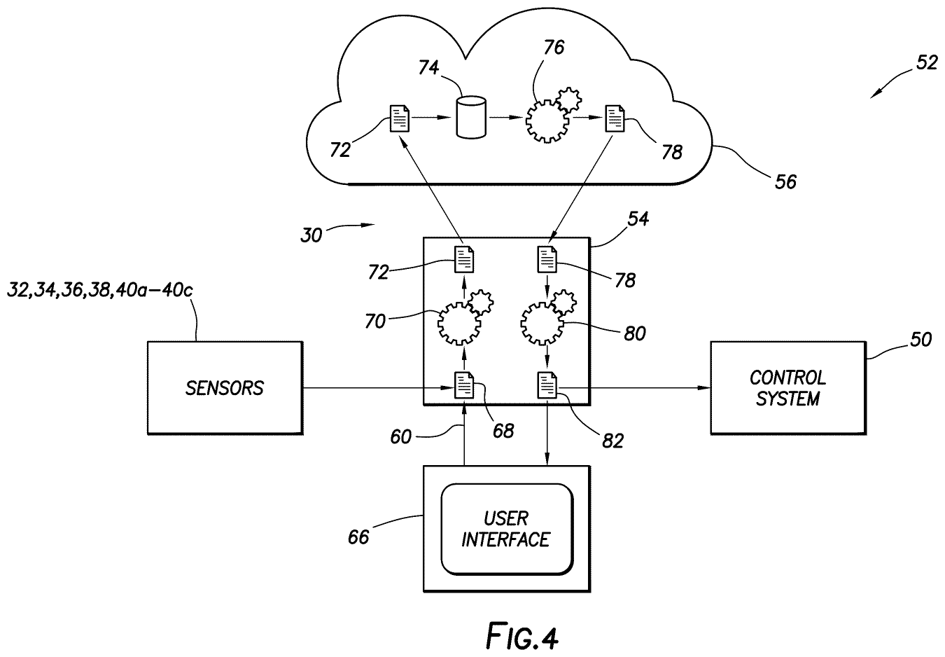

Referring additionally now to FIG. 4, a schematic view of an example of a system 52 for remote threaded connection evaluation is representatively illustrated. For convenience, the threaded connection evaluation system 52 is described below as it may be used with the FIG. 1 or 2 well system 10 and method, but it should be understood that the system 52 may be used with other well systems and methods in other examples.

In the FIG. 4 example, the system 52 includes the apparatus 30, in which the conversion module 54 receives threaded connection parameter measurements from the sensors 32, 34, 36, 38, 40a-c. The conversion module 54 also receives the job information 60 (see FIG. 3), for example, input via a user interface 66. The job data 68 (including, for example, the environmental measurements 58, job information 60 and connection measurements 62) is input to a conversion 70 process, artificial intelligence or algorithm to place the data in a format 72 usable by the central server 56.

The data in the usable format 72 is transmitted to the central server 56. The data is stored, recorded, backed up, etc. (e.g., with appropriate data storage 74). An analysis 76 is performed to determine whether the threaded connection 28 is of acceptable quality (e.g., whether certain technical specifications are met, such as, applied torque, rotation, etc.). The analysis 76 may include use of artificial intelligence, machine learning, genetic algorithms, and/or any other appropriate technique.

An evaluation 78 of the threaded connection quality is produced as a result of the analysis 76. In some examples, the evaluation 78 can be produced automatically in real time as soon as the job data is received by the central server 56.

The evaluation 78 is transmitted from the central server 56 to the job location. Along with the evaluation 78, the central server 56 may produce visualizations of the data 68 (such as, charts, graphs, displays, dashboards, statistical analysis, historical trends, etc.) to aid users in understanding and interpreting the data. If the conversion module 54 is included with the central server 56, the evaluation 78 (including any visualizations, etc.) may be transmitted to the job location after it has been converted to a format 82 usable at the job location, as described below.

The conversion module 54 may perform one or more additional conversions 80 on the output from the central server 56 to place it in formats 82 usable at the job location (for example, for a driller's display, or in a format usable by a third party's equipment, etc.), or at a remote location (for example, if a decision maker or customer is at a location remote from the job location).

In the FIG. 4 example, the user interface 66 (which may be at the job location or at a site remote from the job location) receives the evaluation 78 in the usable format 82. The control system 50 may also receive the evaluation 78 (for example, to permit automatic control of the tong assembly 42), or an operator or other decision maker may interface with the control system after receiving the evaluation (such as, via the user interface 66) and after determining whether the threaded connection 28 should be accepted or rejected.

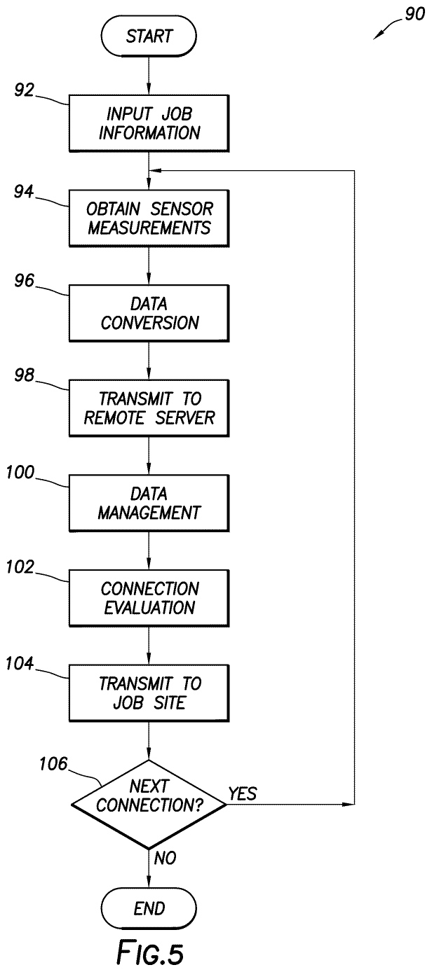

Referring additionally now to FIG. 5, an example of a method 90 of threaded connection evaluation is representatively illustrated in flowchart form. For convenience, the method 90 is described below as it may be used with the system 52 and apparatus 30, but it should be understood that the method 90 may alternatively be used with other systems and apparatus.

In step 92, job information 60 is input. For example, the job information 60 may be input via the user interface 66. The job information 60 may be input at the job location, or at a site remote from the job location.

In step 94, parameter measurements obtained for a threaded connection 28 (e.g., including environmental measurements 58 and connection measurements 62) are obtained. For example, the outputs of the sensors 32, 34, 36, 38, 40a-c may be communicated to the conversion module 54.

In step 96, the job data 68 (e.g., including the job information 60, the connection measurements 62 and the environmental measurements 58) are converted to a format 72 usable by the central server 56 to produce the threaded connection evaluation 78. This conversion 70 may include digitization, filtering, smoothing, or any other appropriate process.

In step 98, the job data 68 in the usable format 72 is transmitted to the central server 56. This transmission may be via wired or wireless communication (such as, via Internet, satellite communication, etc.). If the conversion module 54 is included with the central server 56, the conversion 70 may be performed after the job data 68 is transmitted to the central server.

In step 100, the data received by the central server 56 is stored, backed up, recorded, and/or otherwise managed, so that it is available in the central server 56 for the data analysis 76 and for later historical analysis, training of artificial intelligence, etc.

In step 102, the quality of the threaded connection 28 is evaluated by the central server 56 as a result of the analysis 76. Artificial intelligence, machine learning, genetic algorithms or any other appropriate technique may be used for performing the analysis 76. Alternatively, or in addition, the analysis 76 could comprise a determination of whether certain technical specifications (such as, applied torque and rotation) have been met for the threaded connection 28.

In step 104, the evaluation 78 of the threaded connection 28 is transmitted from the central server 56 to the job location. The evaluation 78 may also be transmitted to a site remote from the job location, if desired. The threaded connection 28 may be automatically accepted or rejected based on the evaluation 78, or an operator or other decision maker may receive the evaluation and then accept or reject the threaded connection based on the evaluation (and/or other factors).

In step 106, if another threaded connection 28 is to be made-up, the method 90 returns to step 94. However, if any job information 60 is changed for the next threaded connection 28, that changed job information can be input, with the method returning instead to step 92.

It may now be fully appreciated that the above disclosure provides significant benefits to the art of evaluating threaded connections for use with a subterranean well. In some examples described above, job data 68 obtained or input at a job location can be converted to a format 72 usable by a remote central server 56. An evaluation 78 of a threaded connection 28 is produced by the central server 56 and transmitted back to the job location.

The above disclosure provides to the art a method 90 of threaded connection evaluation for use with a subterranean well. In one example, the method 90 can comprise: receiving parameters (such as, job information 60, connection measurements 62 and environmental measurements 58) of a threaded connection 28 process at a job location; transmitting the parameters 58, 60, 62 from the job location to a central server 56 remote from the job location; and the central server 56 producing an evaluation 78 of the threaded connection 28.

The method 90 may include transmitting the evaluation 78 of the threaded connection 28 from the central server 56 to the job location. The method 90 may also include an operator at the job location, or at a site remote from the job location, accepting or rejecting the threaded connection 28 based at least in part on the evaluation 78 of the threaded connection 28.

The method 90 may include converting the parameters 58, 60, 62 to a format 72 usable by the central server 56 prior to the transmitting step.

The method 90 may include, after the transmitting, converting the parameters 58, 60, 62 to a format 72 usable by the central server 56 to produce the evaluation 78.

The parameters may comprise torque applied to the threaded connection 28, rotation 44 of a tubular 20 of the threaded connection 28, job information 60, and/or environmental measurements 58.

The above disclosure also provides to the art an apparatus 30 for threaded connection evaluation 78. In one example, the apparatus 30 can comprise: a central server 56 remote from a job location, the central server 56 configured to produce a threaded connection evaluation 78 based on threaded connection parameter measurements 62 output by one or more sensors 32, 34, 36, 38 at the job location; and a conversion module 54 configured to convert the parameter measurements 62 to a format 72 usable by the central server 56 to produce the threaded connection evaluation 78.

The conversion module 54 may be located at the job location. Alternatively, the central server 56 may comprise the conversion module 54.

The central server 56 may comprise a data storage 74 configured to store the converted parameter measurements 62. Alternatively, or in addition, the central server 56 may comprise a data storage 74 configured to store the unconverted parameter measurements 62.

The apparatus 30 may include a user interface 66 configured to receive an operator's acceptance or rejection of a threaded connection 28 based at least in part on the threaded connection evaluation 78. The user interface 66 may be located at the job location, and/or at a site remote from the job location.

The central server 56 may be configured to automatically evaluate a threaded connection 28 upon input of the parameter measurements 62.

The parameter measurements 62 may include at least one of torque applied to a threaded connection 28 and rotation 44 of a tubular 20.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of threaded connection evaluation for use with a subterranean well, the method comprising:
receiving parameters for a threaded connection process at a job location;
transmitting the parameters from the job location to a central server remote from the job location; and
the central server producing an evaluation of the threaded connection.

2. The method of claim 1, further comprising transmitting the evaluation of the threaded connection from the central server to the job location.

3. The method of claim 2, further comprising an operator at the job location accepting or rejecting the threaded connection based at least in part on the evaluation of the threaded connection.

4. The method of claim 2, further comprising an operator at a site remote from the job location accepting or rejecting the threaded connection based at least in part on the evaluation of the threaded connection.

5. The method of claim 1, further comprising converting the parameters to a format usable by the central server prior to the transmitting.

6. The method of claim 1, further comprising, after the transmitting, converting the parameters to a format usable by the central server to produce the evaluation.

7. The method of claim 1, in which the parameters comprise torque applied to the threaded connection.

8. The method of claim 1, in which the parameters comprise rotation of a tubular of the threaded connection.

9. The method of claim 1, in which the parameters comprise job information.

10. The method of claim 1, in which the parameters comprise environmental measurements.

11. An apparatus for threaded connection evaluation, the apparatus comprising:
a central server remote from a job location, the central server configured to produce a threaded connection evaluation based on threaded connection parameter measurements output by one or more sensors at the job location; and
a conversion module configured to convert the parameter measurements to a format usable by the central server to produce the threaded connection evaluation.

12. The apparatus of claim 11, in which the conversion module is located at the job location.

13. The apparatus of claim 11, in which the central server comprises the conversion module.

14. The apparatus of claim 11, in which the central server comprises a data storage configured to store the converted parameter measurements.

15. The apparatus of claim 11, in which the central server comprises a data storage configured to store the unconverted parameter measurements.

16. The apparatus of claim 11, further comprising a user interface configured to receive an operator's acceptance or rejection of a threaded connection based at least in part on the threaded connection evaluation.

17. The apparatus of claim 16, in which the user interface is located at the job location.

18. The apparatus of claim 16, in which the user interface is located at a site remote from the job location.

19. The apparatus of claim 11, in which the central server is configured to automatically evaluate a threaded connection upon input of the parameter measurements.

20. The apparatus of claim 11, in which the parameter measurements include at least one of the group consisting of torque applied to a threaded connection and rotation of a tubular.
